(19) United States
(12) Patent Application Publication
(10) Pub. No.: US 2010/0233816 A1
(43) Pub. Date: Sep. 16, 2010

(54) Tags Dispersible in Organic Solvents

(75) Inventors: Michael J. Natan, Los Altos, CA (US); William E. Doering, Mountain View, CA (US); Rebecca Stoermer Golightly, Belmont, CA (US)

Correspondence Address: SWANSON & BRATSCHUN, L.L.C., 8210 SOUTHPARK TERRACE, LITTLETON, CO, 80120, US

(73) Assignee: OXONICA MATERIALS INC., Mountain View, CA (US)

(21) Appl. No.: 12/723,462

(22) Filed: Mar. 12, 2010

Related U.S. Application Data
(60) Provisional application No. 61/160,201, filed on Mar. 13, 2009.

(51) Int. Cl. G01N 21/65

(52) U.S. Cl. 436/56

(57) ABSTRACT

Methods and compositions of matter are disclosed for creating tags such as SERS nanotags which are dispersible in an organic solvent. The tags are inherently hydrophilic and may be made dispersible in an organic solvent by associating the tag with an amphiphilic polymer. Alternatively, a tag may be associated with a surfactant. In another embodiment a tag having an encapsulant of a silicon containing material may be made dispersible in an organic solvent by modifying the encapsulant surface with a hydrophobic silane. In addition, a tag having an encapsulant of a silicon containing material may be modified by the esterification of the encapsulant with an alcohol.

### RELATED APPLICATIONS

This application claims the benefit under 35 USC section 119 of U.S. provisional application 61/160,201 filed on Mar. 13, 2009 and entitled “Tags with Solubility in Organic Solvents,” the content of which is hereby incorporated by reference in its entirety and for all purposes.

### BACKGROUND

Nano-sized tags can be used to mark any type of substance. Certain tags, for example SERS nanotags, have an encapsulant which makes the entire tag inherently hydrophilic. Other types of tags are hydrophilic as well. It can be difficult or impossible to properly disperse a tag which is innately hydrophilic in an organic solvent.

The present invention is directed toward overcoming one or more of the problems discussed above.

### SUMMARY OF THE EMBODIMENTS

The embodiments disclosed herein include various methods for creating tags which are dispersible in an organic solvent. The tags may be made dispersible in an organic solvent by associating the tag with an amphiphilic polymer. Alternatively, a tag may be associated with a surfactant. In another embodiment a tag having an encapsulant of a silicon containing material may be made dispersible in an organic solvent by modifying the encapsulant surface with a hydrophobic silane. In addition, a tag having an encapsulant of a silicon containing material may be modified by the esterification of the encapsulant with an alcohol.

Other embodiments disclosed herein include compositions of matter such as a SERS-active tag having an encapsulant and a polymer coating or a surfactant associated with the encapsulant. Alternatively, various hydrophobic compositions of matter are disclosed which include a SERS-enhancing core and a silicon containing encapsulant which has been modified with a hydrophobic silane. An alternative hydrophobic composition may include a SERS-enhancing core and a silicon containing encapsulant wherein the surface of the encapsulant has been modified by esterification with an alcohol.

### BRIEF DESCRIPTION OF THE DRAWINGS

FIG. 1(a) is a schematic diagram of a tag within a reverse amphiphilic polymer micelle.

FIG. 1(b) is an SEM image of a SERS nanotag associated with a polymer.

FIG. 2 is a photographic representation of the partitioning of hydrophilic and hydrophobic SERS nanotags in a two phase system.

FIG. 3 is a SEM image of silane modified SERS nanotags.

FIG. 4 is a SEM image of SERS nanotags modified with a selected silane.

FIG. 5 is a SEM image of SERS nanotags modified with a selected silane.

FIG. 6 is a graphic representation of a SERS spectra acquired before and after esterification of SERS nanotags.

FIG. 7 is a SEM image of SERS nanotags after esterification with an alcohol.

### DETAILED DESCRIPTION

The techniques and materials described herein may be applied to any type of particle, nanoparticle or tag which is inherently hydrophilic. It may be desirable to treat a hydrophilic particle to enhance its ability to be effectively dispersed in an organic solvent such as a fuel. One non-exclusive and non-limiting type of tag which is innately hydrophilic but which may be made hydrophobic according to the disclosed methods and materials is a SERS nanotag. SERS nanotags are nanoparticulate optical detection tags which function through surface enhanced Raman scattering (SERS). SERS is a laser-based optical spectroscopy that, for molecules, generates a fingerprint-like vibrational spectrum with features that are much narrower than typical fluorescence.

A typical SERS nanotag includes a metal nanoparticle core and a SiO₂ (glass) or other silicon containing encapsulant. Other materials including but not limited to various types of polymers may also be used as an encapsulant or shell. Details concerning the use, manufacture and characteristics of a typical SERS nanotag are included in U.S. Pat. No. 6,514,767, entitled “Surface Enhanced Spectroscopy-Active Composite Nanoparticles,” which patent is incorporated herein by reference for all matters disclosed therein. Although the embodiments disclosed herein are described in terms of SERS nanotags prepared from single nanoparticle cores, it is to be understood that nanoparticle core clusters or aggregates may be used in the preparation of SERS nanotags. Methods for the preparation of clusters of aggregates of metal colloids are known to those skilled in the art. The use of sandwich-type particles as described in U.S. Pat. No. 6,861,263 is also contemplated, which patent is incorporated herein by reference for all matters disclosed therein.

The nanoparticle core may be of any material known to be Raman-enhancing. The nanoparticle cores may be isotropic or anisotropic. Nanoparticles suitable to be the core of a SERS nanotag include colloidal metal, hollow or filled nanobars, magnetic, paramagnetic, conductive or insulating nanoparticles, synthetic particles, hydrogels (colloids or bars), and the like. The nanoparticles can exist as single nanoparticles, or as clusters or aggregates of the nanoparticles.

Nanoparticles can exist in a variety of shapes, including but not limited to spheroids, rods, disks, pyramids, cubes, cylinders, nanohelixes, nanosprings, nanorings, rod-shaped nanoparticles, arrow-shaped nanoparticles, teardrop-shaped nanoparticles, tetrapod-shaped nanoparticles, prism-shaped nanoparticles, and a plurality of other geometric and non-geometric shapes. Another class of nanoparticles that has been described includes those with internal surface area. These include hollow particles and porous or semi-porous particles. While it is recognized that particle shape and aspect ratio can affect the physical, optical, and electronic characteristics of nanoparticles, the specific shape, aspect ratio, or presence/absence of internal surface area does not bear on the qualification of a particle as a nanoparticle. A nanoparticle as defined herein also includes a nanoparticle in which the metal portion includes an additional component, such as in a core-shell particle.

Each SERS nanotag is typically encoded with a unique reporter, comprising an organic or inorganic molecule at the interface between the nanoparticle core and shell of glass or other suitable encapsulant. This approach to detection tags leverages the strengths of Raman scattering as a high-resolution molecular spectroscopy tool and the enhancements associated with SERS, while bypassing the shortcomings often encountered when making stand-alone SERS substrates such as difficult reproducibility and lack of selectivity. SERS nanotags exhibit intense spectra (enhancement factors in excess of 10⁶) at 633 nm, 785 nm or other suitable excitation wavelengths, which wavelengths can be selected to avoid intrinsic background fluorescence in biological samples such as whole blood and in matrices like glass and plastic.

The encapsulant, which is essentially SERS-inactive, stabilizes the particles against aggregation, prevents the reporter from diffusing away, prevents competitive adsorption of unwanted species, and provides an exceptionally well-established surface. Glass or other silicates are well suited as encapsulants. These silicon containing materials are innately hydrophilic and thus not easily dispersed in an organic solvent.

The disclosure herein includes numerous approaches for enhancing the dispersal of SERS nanotags or other tags with similar hydrophilic surfaces. Disclosed methods include what are defined herein as “passive” and “active” methods. Passive methods generally do not require covalent modification of the silica coating. Thus passive methods include, but are not limited to the application of detergents, surfactants or other materials such as amphiphilic polymer coatings to the tags to increase hydrophobicity.

Alternatively, active methods as described herein involve modification of the silica or other encapsulant to create a hydrophobic surface. For example, active methods include but are not limited to modification of a silica encapsulant with hydrophobic silanes and esterification of the surface with long-chain alcohols. Many of these approaches may be useful either individually or in combination with other methods, and the selected technique ultimately depends on the actual organic solvent or matrix in which nanoparticle dispersal is desired, the required stability of the dispersion, and the ease of implementation.

### I. Passive Methods

### A. Amphiphilic Block Copolymers

Nanoparticles may be coated with amphiphilic block copolymers as a means to alter tag dispersibility. For example, shell-crosslinked (SCL) micelles can be created to encapsulate molecules and particles. Several different configurations of di-block polymers are potentially useful for such coatings, including but not limited to the following: poly(neopentyl methacrylate-b-methacrylic acid) “PMPMA-PMAA”, poly(methyl methacrylate-b-acrylic acid) “PMMA-PAA”, poly(dimethylsiloxane-b-acrylic acid) “PDMS-PAA”, poly(styrene-b-acrylic acid) “PS-PAA”, poly(butadiene(1,2 addition)-b-methylacrylic acid “PBd-PMAA” and similar polymers.

Typically, these and other polymers have been used to form inherently hydrophilic micelles by the controlled addition of aqueous solvent. Thus, both the polymer and particles are dispersed in a mutually good solvent, while the solution is gradually made more polar. This results in a micelle with the non-polar block on the inside and the polar group on the outside. When the polymers have encapsulated a particle, they actually stretch and form a much larger coating than might be expected based on the size of the polymer. For example, a well constructed micelle might contribute over 15 nm of thickness to the particle. A carbodiimide crosslinker can then be used to ‘connect’ acrylic acid groups with a diamine molecule. Resulting polymer shells are stable even upon repeated centrifugation, dispersion in various solvents, and sonication. The hydrophobic core of the micelle has been shown to be accessible by organic solvents, and particles encapsulated with such polymers are often dispersible in a wide variety of solvents. If, however, the particles are exhaustively washed in water, the hydrophobic core effectively shields the encapsulant from aqueous attack (e.g. etching with cyanide). This shielding can be reversed by addition of a small amount of solvent capable of swelling the interior once again.

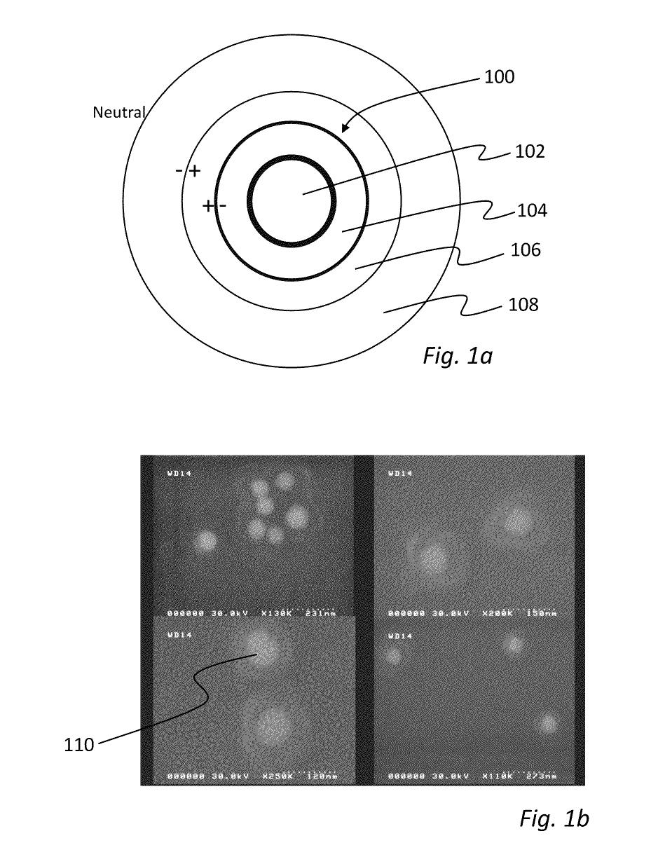

As described in Example 1 below, an opposite approach may be taken to form a micelle around a tag which is hydrophobic on the outside and thus will aid in the dispersal of an included SERS nanotags or similar hydrophilic particle in an organic solvent. In particular, a particle such as a SERS nanotag with a glass encapsulant has a negative surface charge, rendering the particle inherently hydrophilic. A reverse micelle may be formed by first dispersing the tag in a polar liquid such as water or an alcohol and mixing with an amphiphilic polymer. Then, a non-polar liquid may be added causing the polymer to form a micelle with the charged end of the polymer molecule oriented toward the tag/encapsulant surface and the neutral end away from the encapsulant. In certain instances, it may be advantageous to initially coat the negatively charged glass encapsulant with a positively charged layer of polymer, to enhance the subsequent formation of a reverse micelle utilizing an amphiphilic polymer that has a negative charge at the polar block. FIG. 1(a) is a schematic representation of a tag and micelle as described where the tag 100 includes a core 102 and glass encapsulant 104. The encapsulant has a negative charge. The tag 100 is surrounded by an initial layer of positively charged polymer 106. Upon this positive layer, a reverse micelle 108 is constructed of an amphiphilic polymer having a negatively charged polar block on the inside, adjacent to the charged polymer layer (or a positive polar block adjacent to the encapsulant) and a neutral exterior surface.

Crosslinking of the polymer or micelle could be used to further enhance the dispersion characteristics of the encapsulated tags. It is recognized that different crosslinkers, activation chemistries and measures may be used to control the degree of crosslinking. For example, butadiene groups with an initiator such as azobisisobutyronitrile (AIBN) could be used to create a very hydrophobic shell, rendering the nanoparticles stable in pure oils.

One advantage of using a copolymer is that the hydrophobic and hydrophilic blocks can be tailored to provide the best match for the end application. This flexibility could be advantageous, especially if highly specific particle characteristics are required.

### Example 1

A micelle which is hydrophobic on the outside and thus will aid in the dispersal of an included SERS nanotags in an organic solvent was prepared as follows. SERS nanotags were exchanged (via centrifugation/resuspension) into ethanol at a concentration of 20 mg/mL. Fifty microliters of these concentrated SERS tags were placed into 2 mL microcentrifuge tubes. Then, 250 μl of various polymers, (50 mg/mL in THF), was mixed with the tags. Finally, 250 μl of hexane was added, and the tubes were sonicated. The samples that were most stable after addition of hexane were those made with PNPMA-PMAA and PBd-PMAA. FIG. 1(b) shows SEM images of PBD-PMAA coated SERS nanotags 110. It is difficult to confirm the presence of polymer based on these images, though the shells do appear slightly hazier and less conformal than typical glass coatings. However, when coupled with the stability of the dispersions in a mixture of THF and hexanes, it is very likely that polymer is present.

### B. Detergents and Surfactants

An alternative approach to converting glass-coated, hydrophilic SERS tags or similar particles into organic-dispersible materials includes incorporation of the tags into inverse micelles formed with detergents or surfactants. Micelles are formed from molecules which have hydrophobic and hydrophilic ends. When these molecules are placed in water, the hydrophobic tail moves toward the center of the micelle (hydrophobic interacting with hydrophobic) while the hydrophilic head groups interact with the solvent. In non-polar solvents such as most organic solvents, an inverse micelle can form with the hydrophilic head groups in the center and the hydrophobic head groups interacting with the solvent. Depending on the balance of hydrophilic and hydrophobic regions, molecules will be more of less efficient at forming one of either regular micelles (oil-in-water) or inverse micelles (water-in-oil).

### Example 2

Cetyltrimethylammonium bromide (CTAB) was used as a readily available surfactant. The CTAB headgroup is positively charged, which may be an advantage when used to coat the negatively charged silica surface of SERS nanotags.

CTAB solutions were prepared directly in ethanol. Three concentrations of CTAB were prepared, 0.1%, 1.0% and 10% solutions (w/v). SERS nanotags were transferred into ethanol using three successive centrifugation and resuspension steps (to reduce the amount of water). The final tags were resuspended at 20 mg/mL and mixed with 10 microliters of the CTAB/ethanol solution. A series of nine tubes were prepared, resulting in tests of all three CTAB concentrations at different ethanol to hexanes ratios, with the hexanes being a representative organic solvent. A summary of the experimental conditions investigated is detailed in Table 1 below.

TABLE 1
Experimental conditions to test various CTAB concentrations
and ethanol:hexanes ratios for dispersal of SERS
nanotags into organic solvents.

| Volume Nanotags | Concentration | Additional | Volume | |
|---|---|---|---|---|
| (20 mg/mL | CTAB ((w/v) | Ethanol | Hexanes | % Total |
| in Ethanol) | in Ethanol) | (μL) | (μL) | Ethanol |
| 10 μL | 0.1% | — | 180 | 10% |
| 10 μL | 0.1% | 10 | 170 | 15% |
| 10 μL | 0.1% | 30 | 150 | 25% |
| 10 μL | 1.0% | — | 180 | 10% |
| 10 μL | 1.0% | 10 | 170 | 15% |
| 10 μL | 1.0% | 30 | 150 | 25% |
| 10 μL | 10% | — | 180 | 10% |
| 10 μL | 10% | 10 | 170 | 15% |
| 10 μL | 10% | 30 | 150 | 25% |

For all tubes, CTAB and ethanol were added prior to addition of hexanes. After adding hexanes and mixing, there was a clear dependence of dispersal behavior on CTAB quantity. All samples with the lowest CTAB concentration (0.1% solution) were unstable (as evidenced by flocculation), while all samples with the higher CTAB amounts (10%) appeared completely dispersed and stable. The three samples treated with a 1.0% CTAB solution were intermediate, as these samples appeared pseudo-stable; that is, there did appear to be some agglomeration of tags, but they did not precipitate on a short time scale. Thus, a working protocol for dispersion of SERS nanotags into hexanes involves completely exchanging the tags into a 10% CTAB/ethanol solution at a tag concentration of ˜10 mg/mL. Transfer into hexanes may then be completed by simply adding 9 parts of hexanes to the tag/CTAB/ethanol solution and mixing. The subject tags immediately disperse into the hexanes.

### Example 3

Additional investigation was made into alternative methods of micellization to determine if the dispersion consistency or end-result could be improved. For example, different alkanes were investigated to determine the impact of various solvents upon the stability of the dispersions. The alkanes tested were hexanes, n-octane, decane and dodecane. Initially, tags were treated according the protocol described above in Example 2. First, 50 μL was transferred into 10% CTAB (w/v) in ethanol at a tag concentration of 10 mg/mL. Then, 450 μL of the organic solvent was added and the sample was rapidly mixed. This method worked well for all solvents except dodecane, in which two phases formed. For hexane and octane samples, tags initially appeared to disperse, but did settle rapidly, perhaps due to excess CTAB causing stability issues.

### Example 4

Replacement of ethanol with butanol as the CTAB solvent was also investigated. Ten microliters of tags (20 mg/mL in water) were added to 400 μL of hexanes. Then, either 10% CTAB/ethanol or 10% CTAB/n-butanol were added in aliquots. The CTAB/butanol mixture was observed to be a slurry, as CTAB is minimally soluble in butanol. For the ethanol system, no stable dispersion was formed. However, when 60 μL of CTAB/butanol was added, a single-phase was formed, and nanotags appeared to completely disperse. Thus, the composition of the co-solvent was observed to be important to nanotag dispersion in certain instances.

### Example 5

Dodectyltrimethylammonium bromide (DDTAB) was also investigated as an alternative surfactant. It is possible the length of the surfactant carbon chain is of importance to the formation and stability of the micelles. Thus, 500 μL solutions of alkanes containing 10% (w/v) DDTAB were prepared, and 20 mg/mL tags in water were added in 10 μL aliquots. There was no dispersion observed after the addition of 50 μL of tags prepared in this manner to the hexanes solution. However, further addition of 100 μL of 5% CTAB in butanol did lead to a stable, single-phase dispersion. Similar behavior was noted for the octane system, but single-phases could not be obtained for decane/dodecane systems even with addition of CTAB/butanol. Thus, the proper matching of an organic phase with the surfactant is important for the preparation of well-dispersed tags in certain instances.

### Example 6

Solutions were prepared that contained 450 μL of alkane solvent plus 50 μL of 10% CTAB in butanol. Then, tags at 20 mg/mL in water were added. After addition of 12.5 μL tags to each solvent, only the hexanes sample was a clear one-phase system. After the addition of another 12.5 μL of tags, all samples formed two phases. For hexanes and octane, the addition of 50 μL more CTAB/butanol led to a stable dispersion, while decane started to form a stable, single-phase dispersion. The dodecane sample still contained two distinct phases. After adding yet another 50 μL of CTAB/butanol to the dodecane sample, a single phase resulted. To examine the stability of this dispersion, an additional 25 μL of water was added to each sample; the hexanes and octane samples remained well-dispersed while the decane and dodecane samples separated into two phases with the tags in the aqueous phase.

### Example 7

The use of 1-butanol was examined as a replacement for ethanol in a system without water. Tags were transferred into butanol by multiple centrifugation/resuspension cycles at a concentration of 20 mg/mL. They were then added to 250 μL of 10% CTAB solutions (w/v) in each of the alkane solvents listed above. Over the course of three aliquots, a total of 50 μL of tags was added to each solvent. All readily dispersed, though the presence of CTAB was still obvious in each vial; CTAB does not appreciably dissolve in any of the alkane solvents. An additional 100 μL of tags was added to each vial, at which point the hexanes sample began to separate. The addition of 200 μL more hexanes led once again to a stable dispersion. At this point, samples were allowed to sit for over two days. When reexamined, all contained some amount of separated gold ‘flakes,’ with the least amount formed in the decane sample. Simple shaking of the vials redispersed these flakes into solution. More solvent was added at this point to bring the total volume to approximately 2.5 mL. Then, another 125 μL of tags in butanol was added to each. The additional tags dispersed and there were still CTAB crystals visible, but no gold flakes were observed in solution. After about 400 μL of butanol was added most of the remaining crystals appeared to have dissolved. Samples remained stably dispersed for 3 months. Other than the time-frame at which the tags settle, which is primarily a function of solvent viscosity, there were no obvious differences observed among the solvents.

### Example 8

Lecithin, a soy-based emulsifier that contains a large fraction of amphoteric phospholipids was also investigated. Alcolec® S lecithin was obtained from American Lecithin Company; this particular lecithin is quite hydrophobic and was selected to work well for water-in-oil emulsions. The selected lecithin is not soluble in water or ethanol, so it was first prepared as a 10% solution (w/v) in hexanes. Separately, SERS tags were exchanged into ethanol and then hexanes via centrifugation; unmodified nanotags do not disperse in the hexanes, but can be ‘washed’ in the hexane to eliminate residual ethanol. Next, 100 μL of the 10% lecithin/hexanes was added to the SERS tags, followed by an additional 900 μL hexane. The SERS tags dispersed well, suggesting the lecithin was an effective dispersing agent. To test the stability of the dispersion further, 20 μl of water was added to a small aliquot of the lecithin-stabilized particles. The water sank to the bottom of the tube and the tags stayed in the hexane layer, indicating a stable emulsion of nanotags in hexanes.

### C. Layer-by-Layer Deposition

An alternative nanotag coating strategy to enhance the ability of tags to be dispersed in organic solvents is the use of layer-by-layer (LBL) deposition of alternately-charged polymers to build up a coating. Particles or substrates may be exposed to alternating layers of negatively and positively charged polymers. The advantage of this method is its conceptual simplicity and the low reagent cost. However, for nanoparticles, this technique can be a potentially cumbersome as the particles must be washed between each step and introduced very rapidly into the polymer solution to prevent agglomeration. Various types of charged polymer may potentially be used to build a LBL coating, including but not limited to the following: Polyethylenimine, poly(allylamine hydrochloride), poly(acrylic acid) and similar polymers.

There are a number of alternative coating strategies which may be considered. By simply putting on many layers, the coating can be built up substantially. This is a laborious process, but can presumably be completed on relatively concentrated samples. By depositing 10 to 20 alternating layers, the polymer may create a relatively dense shell. In addition, all of the ionic interactions between layers should make the coating very stable. The hydrophobicity could be controlled by the extent of cross-linking, since cross-linking processes functionally “remove” ionic acid/amine groups. Alternatively, hydrophobicity could be controlled by the attachment of selected molecules to the shell. An advantage of cross-linking such a structure is that only the cross-linker itself is required in the cross linking process, since both reactive groups are already present in the polymer. This can both simplify the process and minimize the chance of interparticle cross-linking.

An additional application of the described and similar polymers could be initial modification of the glass surface of the particle to present a positive charge. Thus, if amphiphilic diblock copolymers can be assembled with polar groups on the inside (toward the particle), both ionic interactions and cross-linking might be used to improve the stability. Likewise, layers could be added to the outside of an already present polymer to impact the properties of the particle or enable cross-linking

### Example 9

CTAB forms a bilayer around tags, with the positively charged trimethylammonium group stabilizing the overall structure. Polyelectrolyte layers could be used to further coat the structure which can then be cross-linked to stabilize the entire structure. To implement one embodiment of this method, 100 μL of tags at 20 mg/mL was first mixed with 400 μL of 10% CTAB in water. After heating to 50° C. and allowing slow cooling to promote bilayer formation, the tags were centrifuged once and resuspended in 100 μL water to remove excess CTAB. A 25 μL aliquot of the nanotags thus treated were then rapidly mixed with an excess of poly-acrylic acid (PAA) in water (500 μL at 50 mg/mL) and allowed to tumble for 30 minutes, after which they were cleaned by centrifugation and resuspended in 100 μL of 2 mM sodium phosphate buffer, pH 7.0. Next, the tags were rapidly mixed with an excess of polyethyleneimine (PEI) in water (500 μL at 50 mg/mL) and allowed to equilibrate for 10 minutes. These tags were cleaned by repeated centrifugation/resuspension in water. Resulting tags were allowed to sit overnight before characterization by DLS and zeta potential. For comparison, the original tags were also examined, as were tags with no CTAB, but having 9 layers of PAA/PEI (4 of PAA, 5 of PEI). The observed results are summarized in Table 2:

TABLE 2

| SAMPLE ID | Zeta Potential | DLS Size |
|---|---|---|
| LBL | +14.0 mV | 162 nm |
| LBL over CTAB | +16.3 mV | 176 nm |
| Control | −32.8 mV | 151 nm |

As expected, tags with both CTAB and polyelectrolyte layers are slightly larger than those with only polyelectrolyte (even though there are many more layers) and much larger than the control tags. Additionally, the zeta potential shows a positive surface charge for both sets of tags that were designed to have PEI layers on the outside.

### Example 10

Both sets of polyelectrolyte coated tags prepared as described in Example 9 were diluted into pH 6.5 25 mM phosphate buffer. 1-Ethyl-3-[3-dimethylaminopropyl]carbodiimide hydrochloride (EDC) was added (10-25 μL of 100 mg/mL EDC to approximately 1 mL of tag at 5-20×), and put on a tumbler for 75 minutes, after which they were purified by centrifugation. Significant amounts of each sample stuck to the tube walls after the first and second spins, but relatively good pellets were formed after the third spin. These tags did not appear to be well dispersible in non-polar organic solvents. However, attachment of hydrophobic groups to these readily modified polymers may be a viable option for controlling the hydrophobicity of these polymer coated SERS nanotags.

### II. Active Methods

### A. Hydrophobic Silanes

Many silanes are commercially available that could be used to provide a nonpolar surface on the SERS tags. Suitable silanes for the methods described include but are not limited to isobutyltrimethoxysilane) n-octadecyltrimethoxysilane, methyltrimethoxysilane, 1,2-bis(trimethoxysilyl)decane, hexamethyldisilazane, dichlorodimethylsilane, t-butyldiphenylchlorosilane and similar compounds.

### Example 11

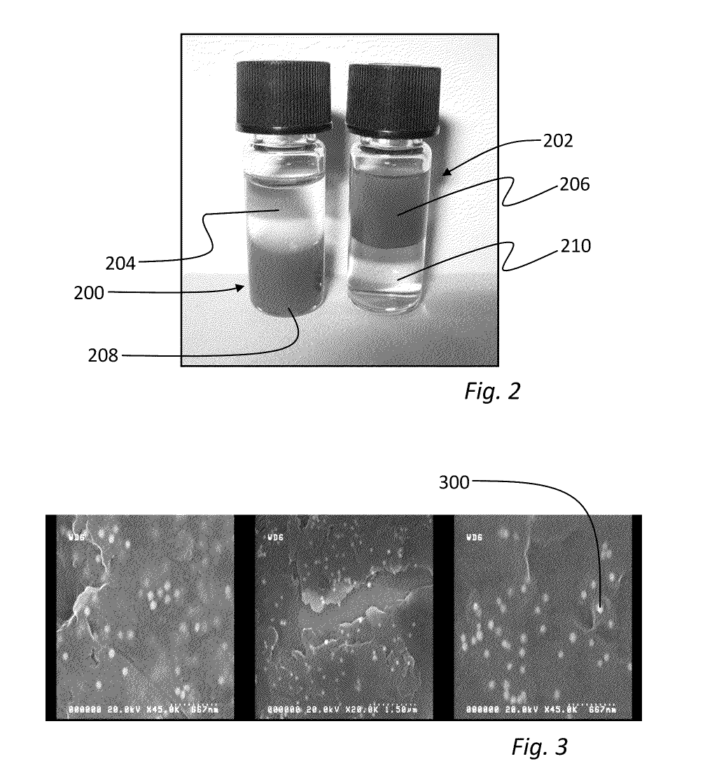

Various silane modifications may be loosely based on the methods used to grow a glass shell on a SERS nanotag. A typical protocol for trimethoxy-silane reagents, for example, is to dilute 1 part SERS nanotags (20 mg/mL in water) with 9 parts ethanol, followed by addition of 0.5 parts neat silane and 0.5 parts concentrated ammonium hydroxide. The solution is stirred for at least two hours before purifying by centrifugation. Generally, these protocols resulted in particles that were still not stable in non-polar solvents such as hexanes or toluene, but exhibited improved stability in solvents such as THF (in which unmodified tags are only mildly stable) or THF/alkane mixtures. While not generally stable in pure alkanes, it was determined that using this method with n-octadecyltrimethoxysilane (ODTMS) does typically produce a nanotag that will not partition from an oil layer into a water layer, indicating a relatively high degree of surface modification. A photographic comparison of unmodified SERS nanotags and hydrophobic SERS nanotags in a two-phase water/hexane system is shown in FIG. 2. The left vial of FIG. 2 includes untreated hydrophilic tags 200 and the right vial includes SERS nanotags 202 treated as described above. In each vial, the upper layer (204 and 206 respectively) is a hexane layer and the lower layer (208 and 210 respectively) is a water layer. As may readily be observed from FIG. 2, only the tags 202 treated with the silane as described above remain dispersed in the organic hexane layers 204, 206. Although the treated tags 202 do not partition into the water layer, they do tend to settle rapidly in the hexanes, implying that there are still hydrophilic regions on the particles. These hydrophilic regions are likely exposed in the presence of oil, as the alkane chains interact with the solvent.

### Example 12

More complete silane induced coatings on tags were also produced. 25 μL of tags at 20 mg/mL in water was briefly mixed with an additional 75 μL water, 500 μL of ethanol, 25 μL of ODTMS and 25 μL of concentrated ammonium hydroxide in a plastic microcentrifuge tube. The tube was then placed in a heating block held at 50° C. and allowed to react for about 90 minutes; heating speeds the reaction, though reactions can be performed at room temperature. During this time, the tags began to clump, with clumping becoming progressively worse as the linkage of an alkyl group to the tags caused instability in the ethanol/water solvent system. Tags were centrifuged and resuspended in THF, followed by another centrifugation and resuspension in toluene. During cleanup, it was obvious that the tags were not well dispersed in THF, but appeared stable in toluene. When the toluene dispersed tags were added to an aliquot of water, the tags remained suspended in the toluene layer. SEM images of tags 300 prepared as described are shown in FIG. 3. The presence of a ‘film’ over the tags may be noted, making the glass shell nearly indiscernible. It may be speculated this is caused by polymer or plasticizers from the microcentrifuge tube that have been solubilized by the toluene.

### Example 13

A number of additional silane coating experiments were undertaken to try to determine the best coating parameters. Adjustments were made to the water content, silane concentration and NH₄OH concentration. Sodium hydroxide was also used as a substitute for ammonium hydroxide, and experiments were attempted with 1,2-bis(trimethoxysilyl)decane, as well.

It was determined that either omission of all water (other than that from NH₄OH) or a 5-fold reduction in NH₄OH resulted in tags that could not be dispersed in non-polar solvents after a two hour reaction. It is likely that both reactions would eventually result in modified surfaces, but that the amount of catalyst is too low for the reaction to complete in the allotted time. Conversely, when 1 M NaOH was used at the same volume as concentrated NH₄OH, the reaction nearly instantly (<1 min) resulted in a gel. After cleanup, the tags appear to disperse in organic solvents, but are very milky, likely due to formation of thicker glass coatings, or formation of free silica particles.

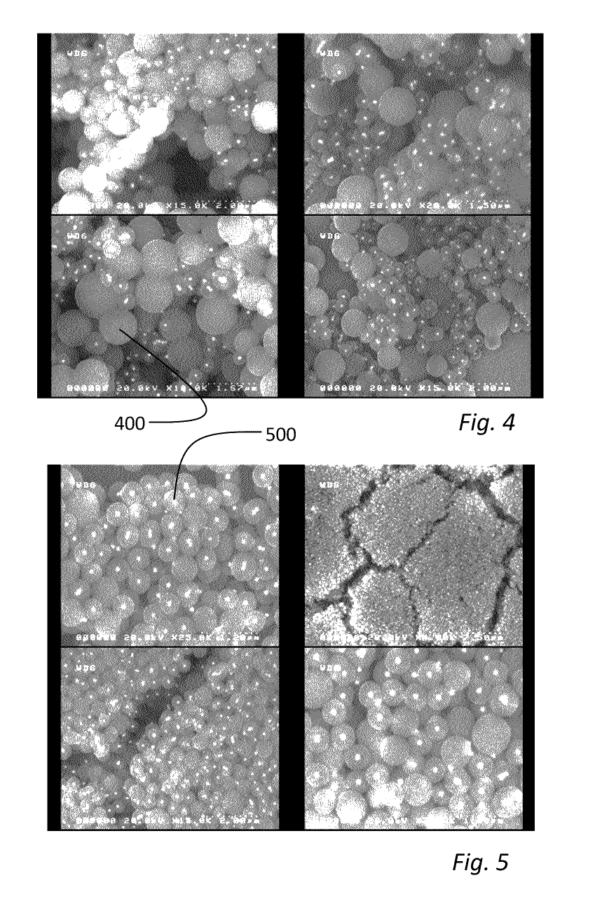

Samples prepared utilizing 1,2-bis(trimethoxysilyl)decane (bTMSD) were investigated. This dipodal silane has the ability to bridge and create a network of glass, whereas the trimethoxy-silanes are likely to produce only mono- to multilayers of glass. One of the samples prepared incorporated equal parts of bTMSD and ODTMS (see particles 400 of the SEM, FIG. 4) In addition, bTMSD was also used as a direct replacement for the C₁₈ silane in an alternative preparation (see particles 500 of the SEM, FIG. 5). Both samples were made under very similar conditions to those described for the ODTMS-modification of Example 11 above. The original tags had only 15-20 nm of glass coating, and it is readily apparent that both modifications result in very thick shells of approximately (˜200 nm), likely due to the use of a dipodal silane. Surprisingly, these tags require medium polarity solvents, such as acetone, to form stable dispersions. Use of the dipodal silane seems to result in exposure of many additional silanol groups, leading to nanotags that display both hydrophilic and hydrophobic characteristics.

### Example 14

Another possible method to confer added hydrophobicity to the nanotags is by capping silanols that were not being modified by the ODTMS. To further attempt to block any surface active (hydroxyl) sites on the silica, an HMDS (hexamethyldisilazane) reaction was investigated. This reagent should be quite reactive, especially when used in conjunction with trichloromethylsilane (TCMS) or chlorodimethylsilane (CDMS). For most reactions, the C₁₈-modified tags are redispersed in primarily alkane solvents, with residual THF accounting for 5-10% of the solution. HMDS is very rapidly degraded in water and can react with alcohols, so care must be taken to eliminate these reagents. A small amount of HMDS was added to the tags under stirring (˜1-10%), followed by the chlorosilane (2-10× less than HMDS). The reaction was then allowed to proceed for up to 2-3 hours, though it is likely completed much more quickly. Only CDMS has been used, though TCMS (trichloromethylsilane) is the ‘classic’ catalyst according (primarily) to pre-column derivitization methods for GC and GC-MS. Two significant observations have been made after addition of the CDMS; when the tag/silane solution is exposed to air, there is a constant evolution of gas. This gas evolution however, appears to cease when the container is capped. Presumably, the gas is HCl or Cl₂ that results from reaction of the chlorosilane. Secondly, it has been noticed that tags occasionally, but not always, clump and precipitate immediately upon addition of the chlorosilane. One possibility is that a byproduct of HMDS/chlorosilane reaction is NH₄⁺Cl⁻ salt, which will form an insoluble precipitate in non-polar solvent and may even coat the tags, causing their precipitation. The observation of precipitation may be obscured by the scale and method of reaction, as it has been most obvious when performed at a very small scale with rotational mixing. Even at a larger scale, the tags are somewhat clumpy after reaction but do remain suspended in the stirred solution. As described above, tags are purified by repeated centrifugation, using alkanes, THF, or a mixture of both to resuspend the pellet. Vigorous sonication is required to place these pellets into solution.

Other modification methods considered include the use of either n-octadecyldimethylmethoxysilane or n-octadecyldimethylchlorosilane as alternatives to the trimethoxy-methods described above. These reagents possess less hydrophilic character and may be able to form more densely packed layers on the nanotags. The problem of particle stability in reaction solvents remains an issue, though; as tags may precipitate from alcohol/water solvents well before uniform coatings can be formed. Another alternative is the reaction of silane reagents in anhydrous solvents, which should minimize the precipitation problem. This may be a viable option, but the reactions tend to be much slower and often proceed more efficiently with heating.

### B. Esterification

An alternative active method of creating a hydrophobic tag includes the use of stearyl alcohol in an esterification reaction with the silica surface.

### Example 15

The esterification method requires heating the tags in a neat stearyl alcohol melt (or other alcohol) under an inert atmosphere. Tags are first dispersed in ethanol then added to a mixture of ethanol and stearyl alcohol. The ethanol is distilled away, and the temperature is increased to drive the reaction forward. Reaction of the tags at approximately 185° C. for a little over two hours was attempted. Cleanup was via centrifugation/resuspension in dichloromethane and/or THF, solvents which are compatible with the stearyl alcohol, which is a solid at room temperature. The tags so prepared were not dispersible in hexanes or toluene.

### Example 16

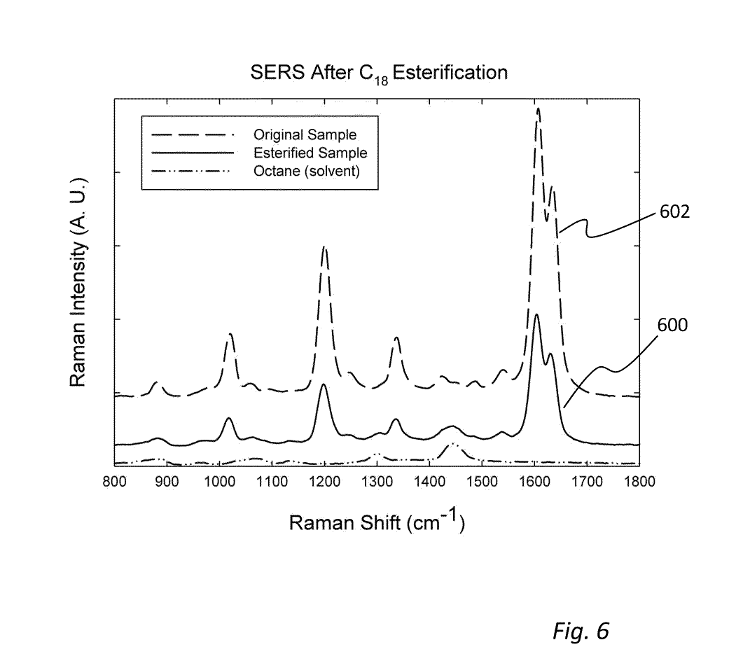

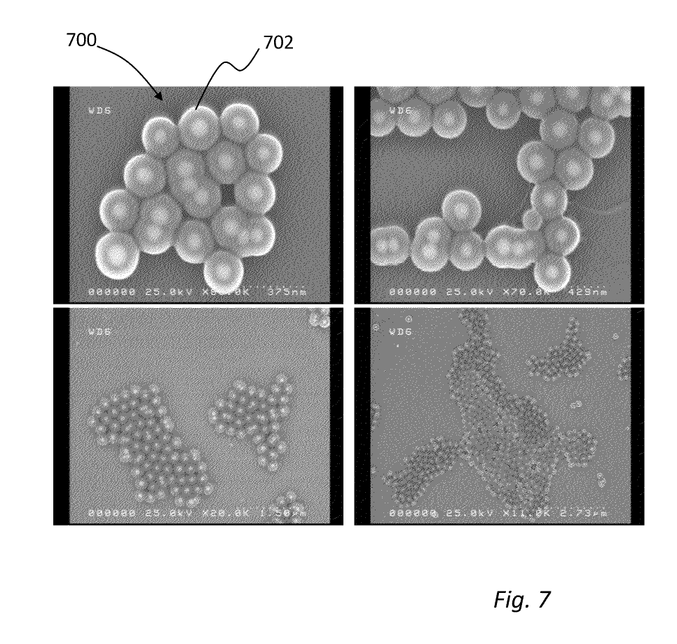

Approximately 200 μL of nanotags at 20 mg/mL ‘400×’ in ethanol were added to 5 g of stearyl alcohol at ˜65° C. (so that it was a liquid) in a 25 mL round-bottom flask. The flask was then heated gradually using an oil bath, and capped with a rubber septum after reaching ˜120° C. This allowed introduction of argon gas at a very low flow rate to provide an inert atmosphere. The reaction was held at 120° C. for one hour, increased to 150° C. and held for another hour, followed by an hour at 170° C. The resulting tags were purified by centrifugation, and resuspended in n-octane. These tags do appear to be stable in the pure alkane solvent, and the viability of the tags has been minimally impacted by the more gradual heating. The SERS intensity spectrum 600 of the tags prepared in this example has dropped by about 50% from the spectrum of untreated tags, 602, as shown in FIG. 6. The UV-Vis spectrum is unchanged from the original sample. SEM images of the tags 700 (FIG. 7) show that the glass shell 702 is intact and indistinguishable from standard hydrophilic nanotags.

Various embodiments of the disclosure could also include permutations of the various elements recited in the claims as if each dependent claim was multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

The description of the present invention has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

1. A method of creating a tag dispersible in an organic solvent comprising:
providing a hydrophilic SERS active tag comprising a SERS enhancing core and an encapsulant; and
associating the hydrophilic SERS active tag with an amphiphilic polymer.

2. The method of claim 1 wherein the step of associating the hydrophilic SERS active tag with an amphiphilic polymer comprises:
dispersing the hydrophilic SERS active tag in a polar liquid;
mixing a polymer with the SERS active tag and polar liquid suspension; and
mixing a non-polar liquid with the mixture of polymer, SERS active tag and polar liquid; thereby causing the polymer to form a reverse micelle with a hydrophilic surface adjacent to the tag encapsulant and a hydrophobic surface away from the encapsulant.

3. The method of creating a tag dispersible in an organic solvent of claim 2 further comprising cross linking the polymer.

4. The method of creating a tag dispersible in an organic solvent of claim 2 wherein the step of associating the SERS active tag with an amphiphilic polymer further comprises depositing one or more alternately charged polymer layers upon the encapsulant.

5. The method of creating a tag dispersible in an organic solvent of claim 2 wherein the polar liquid comprises one of ethanol and water.

6. The method of creating a tag dispersible in an organic solvent of claim 2 wherein the non-polar liquid comprises a hydrocarbon.

7. The method of creating a tag dispersible in an organic solvent of claim 6 wherein the non-polar liquid comprises a hexane.

8. The method of creating a tag dispersible in an organic solvent of claim 2 wherein the polymer comprises at least one of poly(neopentyl methacrylate-b-methacrylic acid), poly(methyl methacrylate-b-acrylic acid), poly(dimethylsiloxane-b-acrylic acid), poly(styrene-b-acrylic acid), and poly(butadiene(1,2 addition)-b-methylacrylic acid.

9. A composition of matter comprising having hydrophobic surface characteristics comprising:
a SERS active tag comprising a SERS enhancing core and an encapsulant; and
a polymer coating associated with the encapsulant.

10. The composition of matter of claim 9 wherein the polymer coating comprises a reverse micelle with a hydrophilic surface adjacent to the tag encapsulant and a hydrophobic surface away from the encapsulant.

11. The composition of matter of claim 9 wherein the polymer coating comprises at least one alternately charged polymer layer deposited upon the encapsulant.

12. The composition of matter of claim 9 wherein the polymer coating comprises at least one of poly(neopentyl methacrylate-b-methacrylic acid), poly(methyl methacrylate-b-acrylic acid), poly(dimethylsiloxane-b-acrylic acid), poly(styrene-b-acrylic acid), and poly(butadiene(1,2 addition)-b-methylacrylic acid.
